(19) United States
(12) Patent Application Publication
(10) Pub. No.: US 2008/0232261 A1
(43) Pub. Date: Sep. 25, 2008

(54) TRANSMISSION APPARATUS, TEST METHOD, AND TRANSMISSION APPARATUS CONTROL PROGRAM

(75) Inventors: Kouichi TSUZAKI, Fukuoka (JP); Katsunori Mawatari, Fukuoka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/049,584

(22) Filed: Mar. 17, 2008

(30) Foreign Application Priority Data
Mar. 19, 2007 (JP) 2007-071657

(51) Int. Cl. G06F 11/00

(52) U.S. Cl. 370/250

(57) ABSTRACT

A transmission apparatus transmits/receives test frames to test connectivity between the transmission apparatus and another transmission apparatus to/from the other transmission apparatus at regular intervals. The transmission apparatus includes a frame length changing unit that changes a frame length, which is capacity of each of the test frames, at every transmission when the test frames are transmitted to the other transmission apparatus at the regular intervals; a reception determining unit that determines whether the test frames having changed frame lengths transmitted from the other transmission apparatus at the regular intervals have been received at the regular intervals; and a frame length calculating unit that calculates the frame length of the test frame that has not been received if the reception determining unit determines that the test frame has not been received.

### CROSS-REFERENCE TO RELATED APPLICATIONS

This application is related to and claims priority to Japanese patent application no. 2007-71657 filed on Mar. 19, 2007 in the Japan Patent Office, the entire disclosure of which is incorporated by reference herein.

### BACKGROUND OF THE INVENTION

Various measures have been made in methods and apparatuses for maintenance in a network using an IP (Internet Protocol) network (e.g., Ethernet®). Recent dramatic development in communication techniques and facilities has caused a rapid increase in services using the IP network. Accordingly, a service providing quality equivalent to that of a dedicated line at low cost has been requested. Under these circumstances, a method and an apparatus enabling a simple maintenance procedure and having a reliable network failure detecting function have been demanded.

For example, Japanese Unexamined Patent Application Publication No. 2004-356854 discloses a system of connectivity testing that can be performed from a terminal apparatus on an arbitrary test section in Ethernet®. Also, a technique about an Ethernet CC (Continuity Check) function is disclosed in IEEE P802.1ag/D6.1 and Ethernet OAM (Operation Administration Management) recommendation ITU-TY1730. This function rapidly detects a failure by transmitting test frames (CCM (Continuity Check Messages) frames) at regular intervals, primarily to check connectivity between an apparatus and another apparatus. Specifically, test frames are transmitted at regular intervals from transmission apparatus A to transmission apparatus B. If transmission apparatus B does not receive the test frames at regular intervals, transmission apparatus B detects a failure (LOC: loss of connectivity) between transmission apparatuses A and B.

Also, a technique about a LB (Loopback) function is disclosed. This function checks whether a frame turned at an apparatus by instructions of a user normally returns, mainly to determine a failure (e.g., to specify a part where the failure has occurred). Also, a technique about a LT (Link Trace) function is disclosed. In this function, a response from a switch through which a frame has passed is used mainly to specify a part where a failure has occurred.

### SUMMARY

According to an aspect of an embodiment, a transmission apparatus transmits/receives test frames to test connectivity between the transmission apparatus and another transmission apparatus to/from the other transmission apparatus at regular intervals. The transmission apparatus includes a frame length changing unit that changes a frame length, which is capacity of each of the test frames, at every transmission when the test frames are transmitted to the other transmission apparatus at the regular intervals; a reception determining unit that determines whether the test frames having changed frame lengths transmitted from the other transmission apparatus at the regular intervals have been received at the regular intervals; and a frame length calculating unit that calculates the frame length of the test frame that has not been received if the reception determining unit determines that the test frame has not been received.

The above-described embodiments of the present invention are intended as examples, and all embodiments of the present invention are not limited to including the features described above.

### BRIEF DESCRIPTION OF THE DRAWINGS

FIG. 1 illustrates an overview and a feature of a transmission apparatus according to a first embodiment;

FIG. 2 is a block diagram illustrating a configuration of the transmission apparatus according to the first embodiment;

FIG. 3 illustrates an example of a transmission policy stored in a test frame transmission policy storing unit according to the first embodiment;

FIG. 4 illustrates a frame format of a normal test frame according to the first embodiment;

FIG. 5 illustrates a frame format of a unique test frame according to the first embodiment;

FIG. 6 illustrates an example of test frame reception information stored in a test frame reception information storing unit according to the first embodiment;

FIG. 7 illustrates an example of specific packet loss failure information stored in a specific packet loss failure information storing unit according to the first embodiment;

FIG. 8 is a flowchart illustrating a test frame transmitting process according to the first embodiment;

FIG. 9 is a flowchart illustrating a test frame receiving process according to the first embodiment;

FIG. 10 is a flowchart illustrating a specific packet loss failure determining process according to the first embodiment;

FIG. 11 is a sequence diagram illustrating an example of a process in the transmission apparatus according to the first embodiment;

FIG. 12 is a flowchart illustrating a receiving process using unique test frames and normal test frames according to a second embodiment;

FIG. 13 is a flowchart illustrating a specific packet loss failure determining process using unique test frames and normal test frames according to the second embodiment;

FIG. 14 is a sequence diagram illustrating an example of a process in the transmission apparatus using only normal test frames according to the second embodiment;

FIG. 15 illustrates programs of the transmission apparatus according to the first embodiment; and

FIG. 16 illustrates an IP network and transmission apparatuses according to a related art.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

A network using an IP network is disadvantageous in that a network failure where only a packet having a specific frame length is discarded cannot rapidly be detected by a continuity check.

More specifically, a maximum of a corresponding frame length (MTU: Maximum Transfer Unit or MRU: Maximum Receive Unit) is set in each of apparatuses constituting a network. Thus, the apparatus in which the MTU is set (e.g., MTU: 1540 bytes) is capable of processing a packet whose frame length is equal to or under the set MTU (e.g. 1540 bytes), but discards a packet whose frame length is longer than the set MTU (e.g., 1541 bytes) when receiving the packet. In this way, a packet size causes a failure (only a packet having a specific frame length is not transmitted in the network).

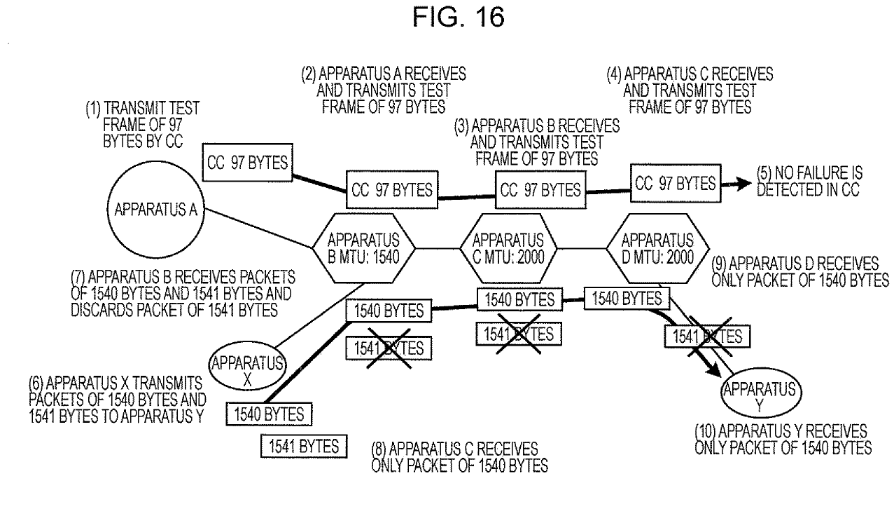

In the network using the IP network, a network failure where only a packet having a specific frame length is discarded cannot rapidly be detected by a continuity check. FIG. 16 illustrates an IP network and transmission apparatuses. As illustrated in FIG. 16, in the above-described continuity check (CC) function, the frame length of test frames is fixed at 97 bytes and a failure occurred due to a packet size cannot be detected.

In the example illustrated in FIG. 16, if a test frame of 97 bytes is transmitted from apparatus A in a continuity check, apparatuses B, C, and D receive this test frame, so that no failure is detected (see (1) to (5) in FIG. 16). On the other hand, if a packet of 1540 bytes and a packet of 1541 bytes are transmitted from apparatus X to apparatus Y, apparatus B having the MTU set to 1540 bytes receives both packets and discards the packet of 1541 bytes, and thus apparatuses C and D receive only the packet of 1540 bytes. As a result, apparatus Y receives only the packet of 1540 bytes (see (6) to (10) in FIG. 16). That is, since the frame length of the test frames to be transmitted in the continuity check is fixed at 97 bytes, occurrence of the failure where only the packet of 1541 bytes is discarded by apparatus B cannot be detected.

For example, in the above-described LB (Loopback) function, a user can specify a frame length. However, this function is used to specify a part having a failure when occurrence of the failure is detected by the continuity check (CC) function while the part to be detected is specified by a user, and is not used as the continuity check. Therefore, a network failure where only a packet having a specific frame length is discarded cannot rapidly be detected.

In the following embodiments, a network failure where only a packet having a specific frame length is discarded is rapidly detected by a continuity check.

### First Embodiment

<Overview and Feature of Transmission Apparatus>

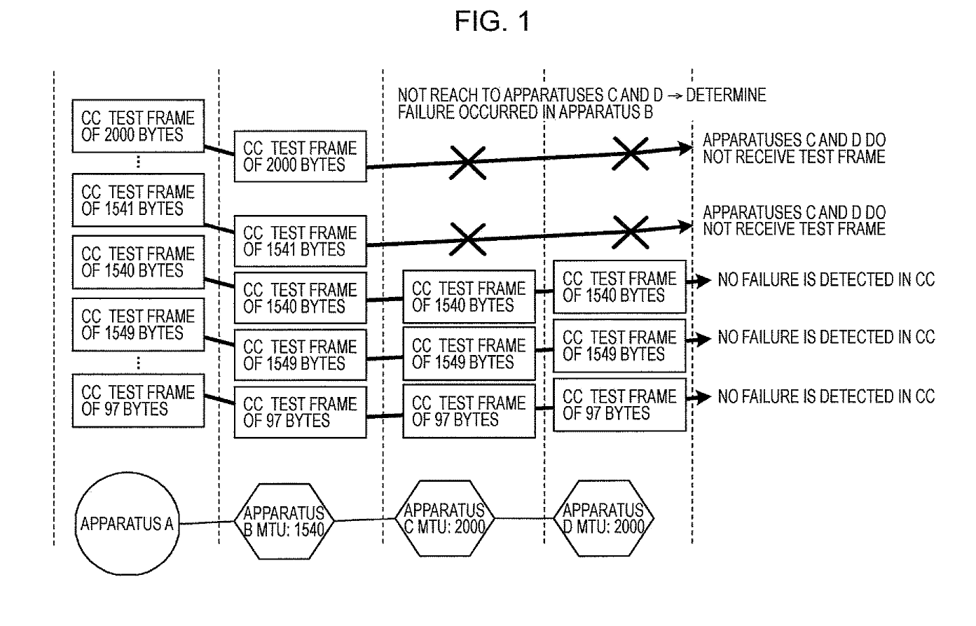

First, an overview and a feature of a transmission apparatus according to this embodiment are described with reference to FIG. 1. FIG. 1 illustrates the overview and feature of the transmission apparatus according to the first embodiment.

As illustrated in FIG. 1, the transmission apparatus according to the first embodiment transmits/receives test frames to test connectivity between the transmission apparatus and another transmission apparatus to/from the other apparatus at regular intervals. As described below, this transmission apparatus is mainly characterized in being capable of rapidly detecting occurrence of a specific packet loss failure, which is a network failure where only a packet having a specific frame length is discarded, by performing a continuity check (CC).

That is, as illustrated in FIG. 1, respective transmission apparatuses are communication apparatuses or switches, for example, and a maximum of a corresponding frame length (MTU: Maximum Transfer Unit or MRU: Maximum Receive Unit) is set in each of the apparatuses. More specifically, in the example illustrated in FIG. 1, “MTU: 1540” is set in apparatus B, “MTU: 2000” is set in apparatus C, and “MTU: 2000” is set in apparatus D. In those transmission apparatuses, test frames are transmitted/received to/from each other at regular intervals mainly to check connectivity between the transmission apparatuses (e.g., between apparatuses B and C).

When the transmission apparatus according to the first embodiment transmits test frames to another transmission apparatus at regular intervals, the transmission apparatus changes a frame length, which is the capacity of each test frame, at every transmission. Specifically, the transmission apparatus changes the frame length by changing the capacity in a reserved area, which is an unused area of the test frame. In the example illustrated in FIG. 1, apparatus A transmits not normal test frames of a fixed frame length but unique test frames of various capacities in the reserved area, e.g., from 97 bytes to 2000 bytes, to apparatuses B, C, and D by multicast.

Then, the transmission apparatus according to the first embodiment determines whether it has received test frames having changed frame lengths transmitted from another transmission apparatus at regular intervals. Specifically, in the example illustrated in FIG. 1, if apparatus C receives a test frame transmitted from apparatus B at a regular interval (e.g., a test frame of “1540 bytes”) after receiving a test frame of “1549 bytes” from apparatus B, apparatus C determines it has received the test frame at the regular interval. On the other hand, if apparatus C does not receive a test frame transmitted from apparatus B at the regular interval (e.g., a test frame of “1541 bytes”) after receiving the test frame of “1540 bytes” from apparatus B, apparatus C determines it has not received the test frame at the regular interval from apparatus B. Also, apparatus D makes a determination in the same manner.

After determining that the test frame has not been received, the transmission apparatus according to the first embodiment calculates the frame length of the test frame that has not been received. In the example illustrated in FIG. 1, if apparatus C determines that it has not received a test frame from apparatus B at the regular interval after receiving the test frame of “1540 bytes” from apparatus B, apparatus C calculates the frame length of the test frame that has not been received, that is, “1541 bytes”.

With the above-described feature, the transmission apparatus according to the first embodiment is capable of rapidly detecting occurrence of a specific packet loss failure, which is a network failure where only a packet having a specific frame length is discarded, by performing a continuity check.

<Configuration of Transmission Apparatus>

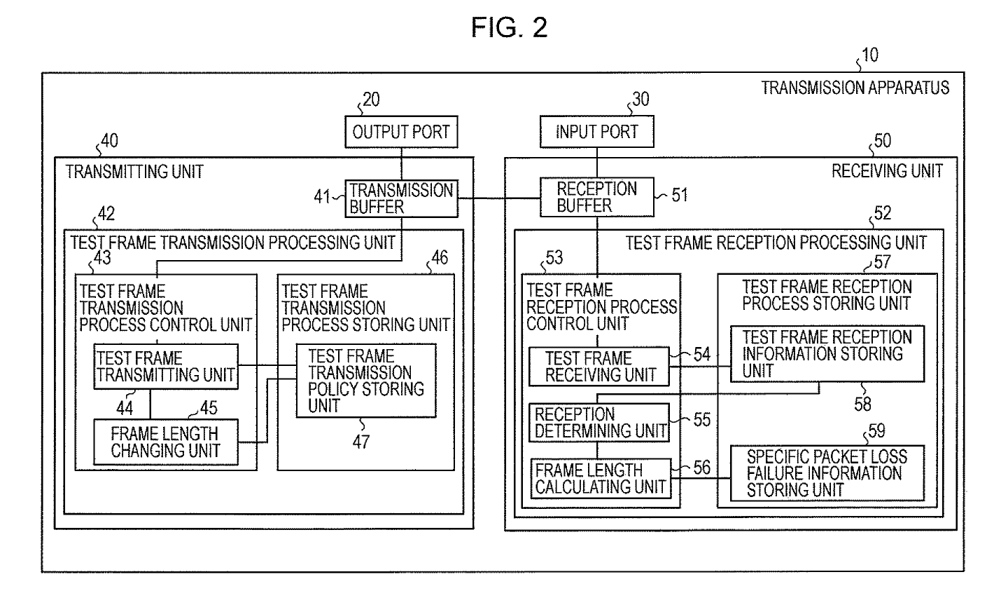

Now, a configuration of the transmission apparatus according to the first embodiment is described with reference to FIG. 2. FIG. 2 is a block diagram illustrating a configuration of the transmission apparatus according to the first embodiment. As illustrated in FIG. 2, the transmission apparatus 10 includes an output port 20, an input port 30, a transmitting unit 40, and a receiving unit 50. In the following description about the configuration of the transmission apparatus according to the first embodiment, an importance is placed on the parts closely related to this embodiment. The other parts are the same as those of a related art, and the description thereof will be omitted or briefly given.

The output port 20 outputs various information to another transmission apparatus. Specifically, the output port 20 outputs data (e.g., test frames to be transmitted to another transmission apparatus) stored in a transmission buffer 41 (described below) in accordance with instructions of the transmitting unit 40 (described below). On the other hand, the input port 30 receives various information from another transmission apparatus. Specifically, the input port 30 receives data (e.g., test frames transmitted from another transmission apparatus) and stores the data in a reception buffer 51 (described below) in accordance with instructions of the receiving unit 50 (described below).

The transmitting unit 40 performs a process of transmitting various information. Specifically, the transmitting unit 40 transmits the data stored in the transmission buffer 41 via the output port 20. The transmitting unit 40 includes, as elements closely related to this embodiment, the transmission buffer 41 and a test frame transmission processing unit 42, as illustrated in FIG. 2. The description given below is about a case of performing a process of transmitting test frames according to this embodiment. However, the process performed by the transmitting unit 40 is not limited to this process. The transmitting unit 40 also performs a process of transmitting other information (e.g., packets transmitted by a user and test frames not related to this embodiment).

The transmission buffer 41, which is a memory, for example, stores the data to be transmitted from the transmission apparatus 10 to another apparatus. The transmission buffer 41 stores test frames controlled by the test frame transmission processing unit 42.

The test frame transmission processing unit 42 performs a process of transmitting test frames to test connectivity between the transmission apparatus 10 and another transmission apparatus to the other apparatus at regular intervals. The test frame transmission processing unit 42 includes, as elements closely related to this embodiment, a test frame transmission process control unit 43, a test frame transmission process storing unit 46, and a test frame transmission policy storing unit 47, as illustrated in FIG. 2.

The test frame transmission process storing unit 46 stores various data and programs required in a test frame transmitting process, for example, a format of frames to be transmitted as test frames.

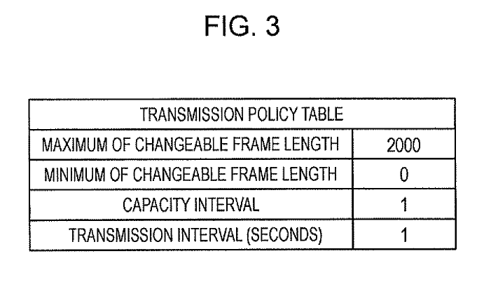

The test frame transmission policy storing unit 47 stores a transmission policy required to transmit test frames. Specifically, as illustrated in FIG. 3, the test frame transmission policy storing unit 47 stores a transmission policy in a transmission policy table illustrated in FIG. 3. The transmission policy table shows “maximum of changeable frame length” indicating a maximum of a frame length that can be changed by a frame length changing unit 45 (described below), “minimum of changeable frame length” indicating a minimum of the frame length that can be changed by the frame length changing unit 45, “capacity interval” indicating an interval of capacity of the frame length that is regularly changed by the frame length changing unit 45, and “transmission interval (seconds)” indicating a transmission interval of the test frames transmitted by a test frame transmitting unit 44 (described below).

In the example illustrated in FIG. 3, the test frame transmission policy storing unit 47 stores “2000” as “maximum of changeable frame length”, stores “0” as “minimum of changeable frame length”, stores “1” as “capacity interval”, and stores “1” as “transmission interval (seconds)”. Note that FIG. 3 illustrates an example of the transmission policy stored in the test frame transmission policy storing unit 47 according to the first embodiment.

The test frame transmission process control unit 43 includes an internal memory to store programs and data defining various processes, so as to perform the various processes. For example, the test frame transmission process control unit 43 performs various processes required to transmit test frames. The test frame transmission process control unit 43 includes, as elements closely related to this embodiment, the test frame transmitting unit 44 and the frame length changing unit 45, as illustrated in FIG. 2.

The test frame transmitting unit 44 transmits test frames to test connectivity between the transmission apparatus 10 and another apparatus to the other apparatus at regular intervals. Specifically, the test frame transmitting unit 44 stores the test frames to be transmitted based on instructions of the frame length changing unit 45 in the transmission buffer 41 and transmits the test frames to another transmission apparatus at the regular intervals.

The frame length changing unit 45 changes a frame length, which is the capacity of each test frame, every time a test frame is transmitted to another transmission apparatus at the regular interval. Specifically, the frame length changing unit 45 changes the frame length by changing the capacity in a reserved area, which is an unused area in the test frame.

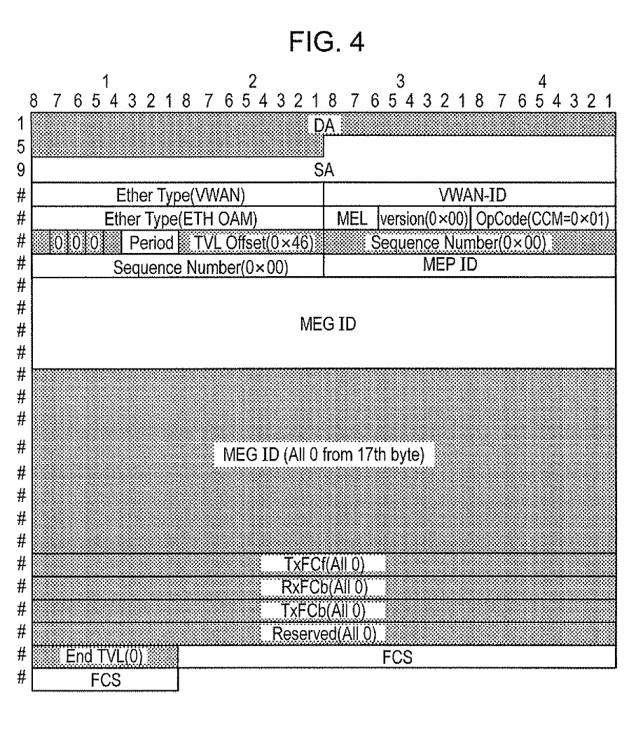

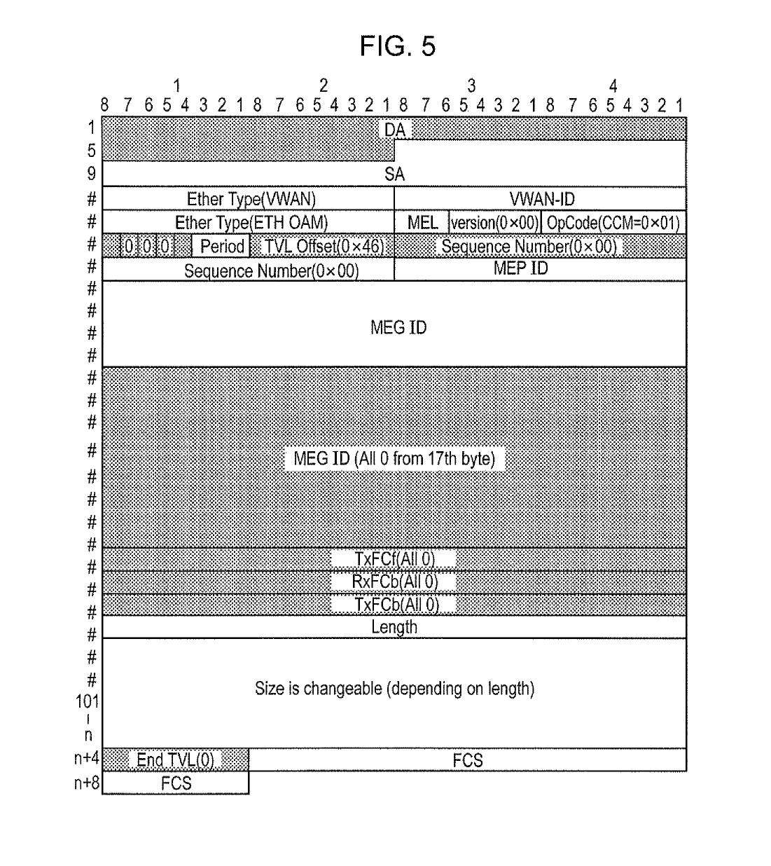

For example, as illustrated in FIGS. 4 and 5, the frame length changing unit 45 changes the capacity in the reserved area (e.g., see “Reserved (All 0)” in FIG. 4), which is an unused area of a normal test frame, so as to change the frame length at every transmission. As illustrated in FIG. 5, the reserved area is used as an area indicating the size of the test frame (e.g., see “Length” and “Size is changeable (depending on length)” in FIG. 5). FIG. 4 illustrates a frame format of a normal test frame according to the first embodiment, and FIG. 5 illustrates a frame format of a unique test frame according to the first embodiment.

FIGS. 4 and 5 illustrate the formats of test frames. “DA” is a multicast address set as DA for OAM (e.g., lower 4 bits are automatically set by MEG Level). “SA” is a MAC address of the own apparatus. “Ether Type (VWAN)” is Ether Type. “VWAN-ID” is a VWAN value to which a source MEP is assigned. “Ether Type (ETH OAM)” is Ether Type set as Ether Type for OAM. “MEL” is MEG Level (Operation 1 is set in units of apparatuses) of the source MER “Version” is 0 (e.g., a received frame of different version is discarded). “OpeCode” is 1 (CCM). “Period” is an interval of CCM transmission/reception (e.g., 1 s: 4, 10 s: 5, or 60 s: 6). “TVL Offset” is 70 (decimal). “Sequence Number” is unused (all 0 setting is recommended). “MEP ID” is MEP ID of the source MEP. “MEG ID” is MEG ID of the source MEP. “TxFCf” is a local counter at CCM frame transmission. “RxFCb” is a local counter at final CCM frame reception from opposite MEP “TxFcb” is a final TxFCf value when a CCM frame is received from the opposite MEP. “Reserved” is a reserved area. “Length” is an area, which is a reserved area unused (fixed at 0) in a normal test frame, indicating a frame size. “FCS” is an area for detecting an error by using a checksum to detect an error. “All 0” indicates unused (fixed at 0). “ME” (Maintenance Entity) indicates a section to perform maintenance by using a test frame. “MEG” (Maintenance Entity Group) indicates a group of ME. “MEP” indicates an end point of ME to terminate the test frame.

In the format of a normal test frame illustrated in FIG. 4, “DA”, “TLV Offset”, “Sequence Number”, “MEG ID (All 0 from 17th byte)”, “TxFCf”, “RxFCb”, “TxFCb”, and “Reserved” are not considered at reception of the test frame. On the other hand, in the format of a unique test frame illustrated in FIG. 5, “DA”, “TLV Offset”, “Sequence Number”, “MEG ID (All 0 from 17th byte)”, “TxFCf”, “RxFCb”, and “TxFCb” are not considered at reception of the test frame.

The frame length changing unit 45 regularly changes the frame length in the range of the preset maximum frame length and/or minimum frame length, and/or regularly changes the frame length at the preset capacity interval. More specifically, the frame length changing unit 45 reads the transmission policy stored in the test frame transmission policy storing unit 47, that is, “maximum of changeable frame length”, “minimum of changeable frame length”, “capacity interval”, and “transmission interval (seconds)”. Then, the frame length changing unit 45 determines and changes the frame length of the test frame by using the read transmission policy, and instructs the test frame transmitting unit 44 to transmit the test frame.

In the example illustrated in FIG. 3, the frame length changing unit 45 reads “maximum of changeable frame length: 2000”, “minimum of changeable frame length: 0”, “capacity interval: 1”, and “transmission interval (seconds): 1” at transmission timing, determines the frame length of the test frame to be transmitted at a capacity interval of “1” in the range of “0” to “2000”, and instructs the test frame transmitting unit 44 to transmit the test frame.

The transmitting unit 40 transmits this test frame, and also performs a process of transmitting (relaying) a test frame that is transmitted from another apparatus and is input via the input port 30 to another apparatus.

The receiving unit 50 performs a process of receiving various information. Specifically, the receiving unit 50 receives data stored in the reception buffer 51 (described below) via the input port 30. The receiving unit 50 includes, as elements closely related to this embodiment, the reception buffer 51 and a test frame reception processing unit 52, as illustrated in FIG. 2. The description given below is about a case of performing a process of receiving test frames according to this embodiment. However, the process performed by the receiving unit 50 is not limited to this process. The receiving unit 50 also performs a process of receiving other information (e.g., packets received by a user and test frames not related to this embodiment).

The reception buffer 51, which is a memory, for example, stores data transmitted from another transmission apparatus and received by the transmission apparatus 10. The reception buffer 51 stores test frames controlled by the test frame reception processing unit 52.

The test frame reception processing unit 52 performs a process of receiving test frames to test connectivity between the transmission apparatus 10 and another transmission apparatus from the other apparatus at predetermined intervals. The test frame reception processing unit 52 includes, as elements closely related to this embodiment, a test frame reception process control unit 53, a test frame reception process storing unit 57, a test frame reception information storing unit 58, and a specific packet loss failure information storing unit 59, as illustrated in FIG. 2.

The test frame reception process storing unit 57 stores various data and programs required in a test frame receiving process, for example, a format of frames received as test frames.

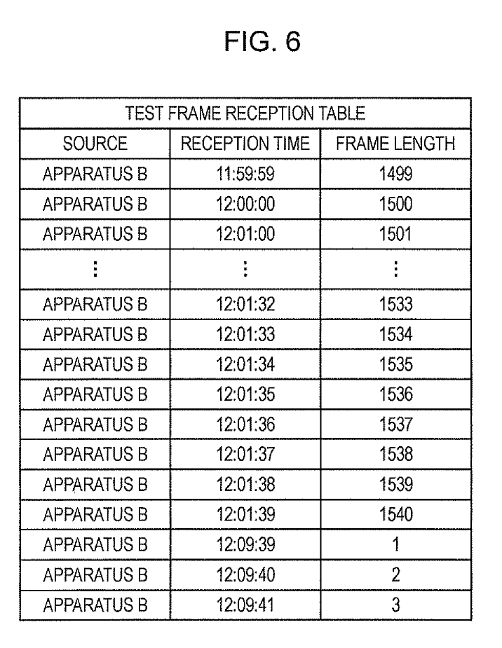

The test frame reception information storing unit 58 stores information about test frames received by the receiving unit 50 in accordance with instructions of the test frame receiving unit 54. Specifically, the test frame reception information storing unit 58 stores a test frame reception table illustrated in FIG. 6. The test frame reception table shows “source” indicating a transmission apparatus that transmitted the test frame received by the receiving unit 50, “reception time” indicating the time when the test frame was received, and “frame length” indicating the length of the test frame.

In the example illustrated in FIG. 6, the test frame reception information storing unit 58 stores “apparatus B”, “11:59:59”, and “1499” as “source”, “reception time”, and “frame length” by associating them with each other. Also, the test frame reception information storing unit 58 stores “apparatus B”, “12:01:39”, and “1540” by associating them with each other, and “apparatus B”, “12:09:39”, and “1” by associating them with each other. FIG. 6 illustrates an example of the test frame reception information stored in the test frame reception information storing unit 58 according to the first embodiment.

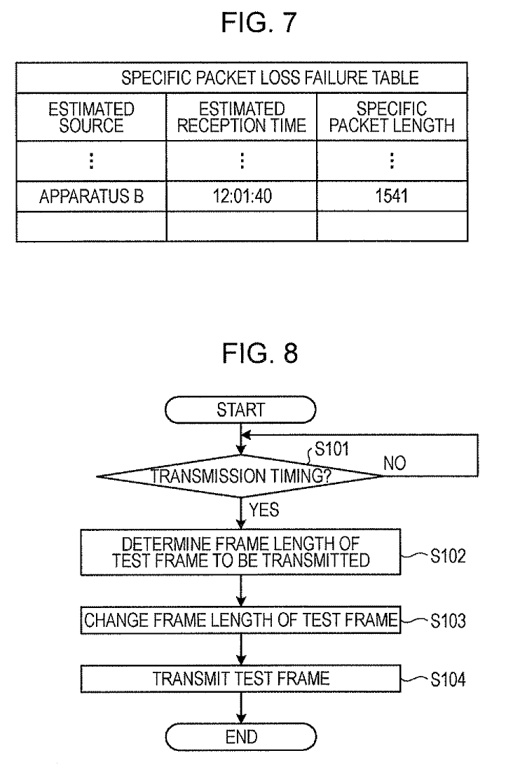

The specific packet loss failure information storing unit 59 stores a frame length of a test frame that has not been received, the frame length being calculated by a frame length calculating unit 56 (described below). Specifically, the specific packet loss failure information storing unit 59 stores a specific packet loss failure table illustrated in FIG. 7, which shows “estimated source” indicating the transmission apparatus from which a test frame was supposed to be received, “estimated reception time” indicating the time when the test frame was supposed to be received, and “specific packet length” indicating the frame length of the test frame that was supposed to be received. FIG. 7 illustrates an example of the specific packet loss failure information stored in the specific packet loss failure information storing unit 59 according to the first embodiment.

In the example illustrated in FIG. 7, the specific packet loss failure information storing unit 59 stores “apparatus B”, “12:01:40” and “1541” as “estimated source”, “estimated reception time”, and “specific packet length” by associating them with each other.

The test frame reception process control unit 53 includes an internal memory to store programs and data defining various processes and performs the various processes accordingly. For example, the test frame reception process control unit 53 performs various processes required to receive test frames. The test frame reception process control unit 53 includes, as elements closely related to this embodiment, the test frame receiving unit 54, a reception determining unit 55, and the frame length calculating unit 56, as illustrated in FIG. 2.

When the transmission apparatus 10 receives test frames transmitted from another transmission apparatus at regular intervals, the test frame receiving unit 54 stores information about the received test frames. Specifically, after test frames have been received, the test frame receiving unit 54 reads “source”, “reception time”, and “frame length” from each of the test frames and stores them in the test frame reception information storing unit 58 by associating them with each other.

The reception determining unit 55 determines whether the transmission apparatus 10 has received a test frame having a changed frame length transmitted from another transmission apparatus at a regular interval. Specifically, the reception determining unit 55 reads “reception time” stored by being associated with an arbitrary “source” from the test frame reception information storing unit 58 at determination timing, and determines whether the transmission apparatus 10 has received a test frame at a predetermined time interval from the read “reception time”.

In the example illustrated in FIG. 6, the reception determining unit 55 reads “11:59:59” to “12:01:39” and “112:09:39” to “112:09:41”, which are “reception times” associated with “apparatus B”, and determines that test frames were not received from “112:01:40” to “112:09:38” at the regular intervals. On the other hand, if test frames were received at the regular intervals, the reception determining process ends.

If it is determined that a test frame was not received, the frame length calculating unit 56 calculates the frame length of the test frame that was not received. Specifically, when the reception determining unit 55 determines that a test frame was not received at the regular interval, the frame length calculating unit 56 reads the “frame length” stored while being associated with the test frame that was received from the same source just before (or just after) the “reception time” when the test frame was not received, and calculates a specific packet length. Then, the frame length calculating unit 56 stores “estimated source”, “estimated reception time”, and “specific packet length” in the specific packet loss failure information storing unit 59 by associating them with each other.

In the example illustrated in FIGS. 6 and 7, if the reception determining unit 55 determines that a test frame was not received from “source: apparatus B” at “reception time: 12:01:40”, the frame length calculating unit 56 reads the frame length “1540” of the test frame that was received from apparatus B at “reception time: 12:01:39”, which is just before the reception time, and calculates a specific packet length “1541” corresponding to “source: apparatus B” and “reception time: 12:01:40”. Then, the frame length calculating unit 56 stores the calculated specific packet length “1541” in the specific packet loss failure information storing unit 59.

### Test Frame Transmitting Process According to the First Embodiment

Hereinafter, a test frame transmitting process according to the first embodiment is described with reference to FIG. 8. FIG. 8 is a flowchart illustrating the test frame transmitting process according to the first embodiment.

As illustrated in FIG. 8, at transmission timing (Yes in operation S101), the frame length changing unit 45 determines the frame length of a test frame to be transmitted (operation S102). That is, the frame length changing unit 45 determines the length of the test frame to be transmitted by reading the transmission policy stored in the test frame transmission policy storing unit 47, and then changes the frame length of the test frame (operation S103).

Then, the test frame transmitting unit 44 transmits the test frame (operation S104), and the test frame transmitting process ends. That is, the test frame transmitting unit 44 stores the test frame to be transmitted by instructions of the frame length changing unit 45 in the transmission buffer 41 so as to transmit the test frame to another transmission apparatus.

### Test Frame Receiving Process According to the First Embodiment

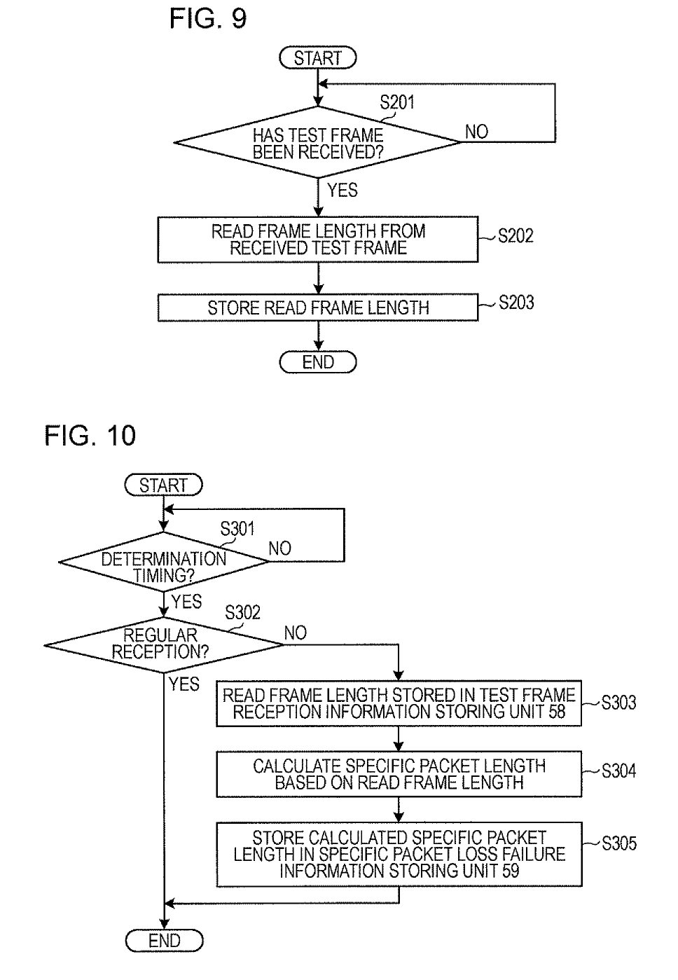

Hereinafter, a test frame receiving process according to the first embodiment is described with reference to FIG. 9. FIG. 9 is a flowchart illustrating the test frame receiving process according to the first embodiment.

As illustrated in FIG. 9, after receiving a test frame (Yes in operation S201), the test frame receiving unit 54 reads a frame length from the received test frame (operation S202). That is, the test frame receiving unit 54 reads “source”, “reception time”, and “frame length” from the test frame.

Then, the test frame receiving unit 54 stores the read frame length (operation S203), and the test frame receiving process ends. That is, the test frame receiving unit 54 stores the read “source”, “reception time”, and “frame length” in the test frame reception information storing unit 58.

### Specific Packet Loss Failure Determining Process According to the First Embodiment

Hereinafter, a specific packet loss failure determining process according to the first embodiment is described with reference to FIG. 10. FIG. 10 is a flowchart illustrating the specific packet loss failure determining process according to the first embodiment.

As illustrated in FIG. 10r at determination timing (Yes in operation S301), the reception determining unit 55 determines whether regular reception is performed (operation S302). That is, the reception determining unit 55 reads “reception time” stored while being associated with an arbitrary “source” from the test frame reception information storing unit 58 and determines whether a test frame was received at a predetermined time interval from the read “reception time”. If regular reception is performed (Yes in operation S302), the specific packet loss failure determining process ends.

On the other hand, if the reception determining unit 55 determines that regular reception is not performed (No in operation S302), the frame length calculating unit 56 reads a frame length stored in the test frame reception information storing unit 58 (operation S303). That is, if the reception determining unit 55 determines that a test frame was not received at the regular interval, the frame length calculating unit 56 reads the “frame length” stored while being associated with the test frame that was received from the same source just before (or just after) the “reception time” when the test frame was not received.

Then, the frame length calculating unit 56 calculates a specific packet length based on the read frame length (operation S304). Then, the frame length calculating unit 56 stores the calculated specific packet length in the specific packet loss failure information storing unit 59 (operation S305), and the specific packet loss failure determining process ends. That is, “estimated source”, “estimated reception time”, and “specific packet length” are stored in the specific packet loss failure information storing unit 59 while being associated with each other.

### Example of Process in Transmission Apparatus According to the First Embodiment

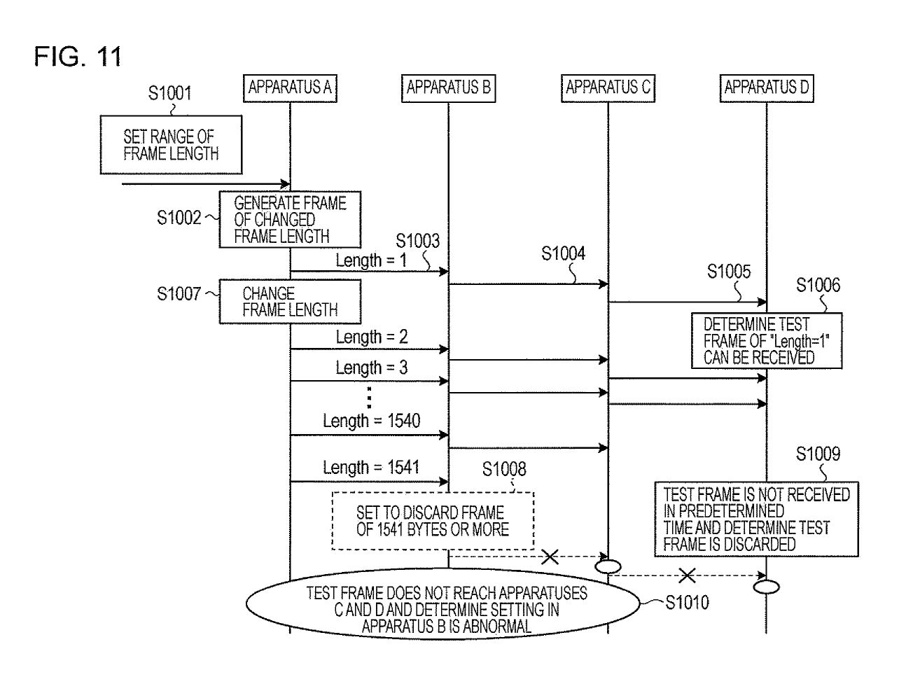

Hereinafter, an example of a process in the transmission apparatus according to the first embodiment is described with reference to FIG. 11. FIG. 11 is a sequence diagram illustrating an example of a process in the transmission apparatus according to the first embodiment. In the following description, each of apparatuses A to D is the transmission apparatus according to the first embodiment. As in apparatuses A to D illustrated in FIG. 1, apparatus A connects to apparatus B, apparatus B connects to apparatus C, apparatus C connects to apparatus D, and occurrence of a specific packet loss failure between apparatus A and apparatus D is detected.

As illustrated in FIG. 11, a range of changeable frame length of a test frame is set to apparatus A (operation S1001). Specifically, “maximum of changeable frame length”, “minimum of changeable frame length”, and “capacity interval” are preset. Then, apparatus A generates a test frame by changing the frame length to “Length=1” (operation S1002), and transmits it to apparatus B (operation S1003). Then, apparatus B receives the test frame of “Length=1” from apparatus A and transmits the test frame of the same frame length to apparatus C (operation S1004). Then, apparatus C receives the test frame of “Length=1” from apparatus B and transmits the test frame of the same frame length to apparatus D (operation S1005). As a result, it is determined that the test frame of “Length=1” can be transmitted/received between apparatuses A and D (operation S1006).

After that, apparatus A changes the frame length at every transmission (operation S1007). When apparatus A transmits a test frame of “Length=1541” to apparatus B, in which setting is made to discard a frame of 1541 bytes or more (operation S1008), the test frame is not transmitted from apparatus B to apparatus C. Accordingly, apparatuses C and D do not receive the test frame within predetermined time, and thus it is determined that the test frame has been discarded (operation S1009). As a result, since the test frame of “Length=1541” does not reach apparatuses C and D, it is determined that the setting in apparatus B is abnormal (operation S1010).

### Advantages of the First Embodiment

As described above, according to the first embodiment, when the transmission apparatus transmits test frames to another transmission apparatus at regular intervals, the transmission apparatus changes the frame length (capacity) of the test frames at every transmission. Also, the transmission apparatus determines whether the transmission apparatus has received each test frame of a changed frame length transmitted from another transmission apparatus at the regular interval. If the transmission apparatus determines that it has not received a test frame, the transmission apparatus calculates the frame length of the test frame that has not been received. Therefore, occurrence of a specific packet loss failure, which is a network failure where only a packet having a specific packet length is discarded, can be rapidly detected by performing a continuity check.

According to the first embodiment, the transmission apparatus changes the frame length by changing the capacity in the reserved area, which is an unused area of the test frame. Thus, a test frame used in a normal continuity check where the frame length is not changed can be used, and occurrence of a specific packet loss failure can be detected even if an apparatus incompatible with this embodiment exists in the network. Furthermore, a continuity check can be performed by changing the frame length while using a test frame used in a normal continuity check, and thus occurrence of a specific packet loss failure can be detected without using or installing a dedicated apparatus.

According to the first embodiment, the transmission apparatus regularly changes the frame length in the range of the preset maximum frame length and/or minimum frame length. Thus, a specific packet loss failure can be flexibly detected, e.g., by setting a frame length not causing the specific packet loss failure out of the range.

According to the first embodiment, the transmission apparatus regularly changes the frame length at the preset capacity interval. Thus, a specific packet loss failure can be flexibly detected, e.g., by increasing the capacity interval of the frame length that is regularly changed if a specific packet loss failure should be detected in short time.

### Second Embodiment

In the first embodiment, only unique test frames of a changeable frame length are used. However, the present invention is not limited to this, but normal test frames of a fixed frame length can be used together. In the second embodiment, a case where normal test frames of a fixed frame length are used together is described. In the following description, the same part as that of the transmission apparatus according to the first embodiment is briefly described.

The transmission apparatus according to the second embodiment determines whether the capacity in the reserved area is changed after receiving a test frame from another transmission apparatus. For example, the transmission apparatus determines whether the reserved area is “All 0” as illustrated in FIG. 4 (see “Reserved (All 0)” in FIG. 4) or the reserved area is used as “Length” and the capacity is changed as illustrated in FIG. 5 (see “Length” and “Size is changeable (depending on length)” in FIG. 5).

If the transmission apparatus according to the second embodiment determines that the reserved area is changed, the transmission apparatus determines that the test frame is a unique test frame of a changeable frame length and determines whether the test frame was received at the regular interval. If unchanged capacity in the reserved area is observed, the transmission apparatus determines that the test frame is a normal test frame of a fixed frame length and determines whether the test frame was received at the regular interval.

For example, if the transmission apparatus according to the second embodiment determines that the reserved area is used as “Length” and the capacity is changed as illustrated in FIG. 5, the transmission apparatus determines that the test frame is a unique test frame and determines whether the test frame was received at the regular interval. On the other hand, if the reserved area is “All 0” as illustrated in FIG. 4, the transmission apparatus determines that the test frame is a normal test frame and determines whether the test frame was received at the regular interval.

In this way, the transmission apparatus according to the second embodiment can easily distinguish between a normal continuity check and a continuity check according to this embodiment, and thus both types of continuity check can be easily used together.

### Receiving Process Using Both Types of Test Frames According to the Second Embodiment

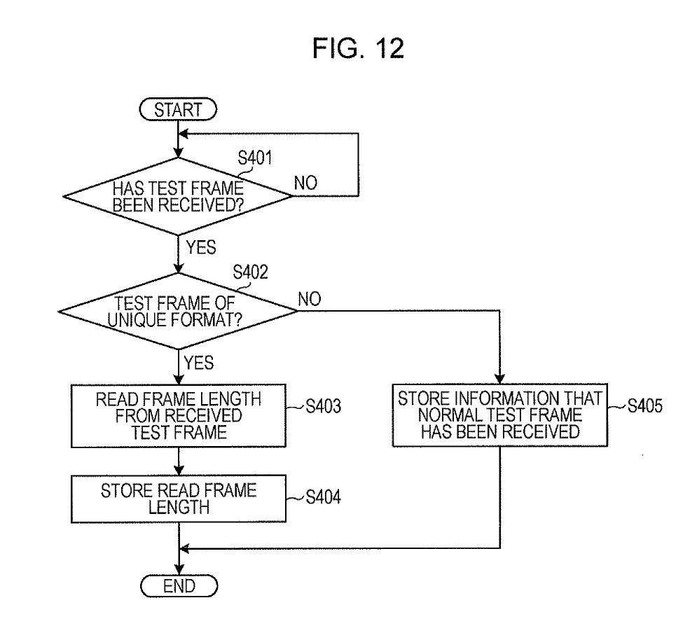

Hereinafter, a receiving process using unique test frames and normal test frames according to the second embodiment is described with reference to FIG. 12. FIG. 12 is a flowchart illustrating a receiving process using unique test frames and normal test frames according to the second embodiment.

As illustrated in FIG. 12, if the transmission apparatus according to the second embodiment receives a test frame (Yes in operation S401), the transmission apparatus determines whether the test frame is a unique test frame (operation S402). In other words, the transmission apparatus determines whether the capacity in the reserved area is changed. If the test frame is not a unique test frame (No in operation S402), that is, if the test frame is a normal test frame of a fixed frame length, the transmission apparatus stores information that a normal test frame has been received in a predetermined storing unit (operation S405), and the receiving process ends. In the example illustrated in FIG. 2, the information is stored in the test frame reception information storing unit 58.

On the other hand, if the transmission apparatus according to the second embodiment receives a unique test frame (Yes in operation S402), the transmission apparatus reads a frame length from the received test frame (operation S403) and stores the read frame length (operation S404), and then the receiving process ends.

### Specific Packet Loss Failure Determining Process Using Both Types of Test Frames According to the Second Embodiment

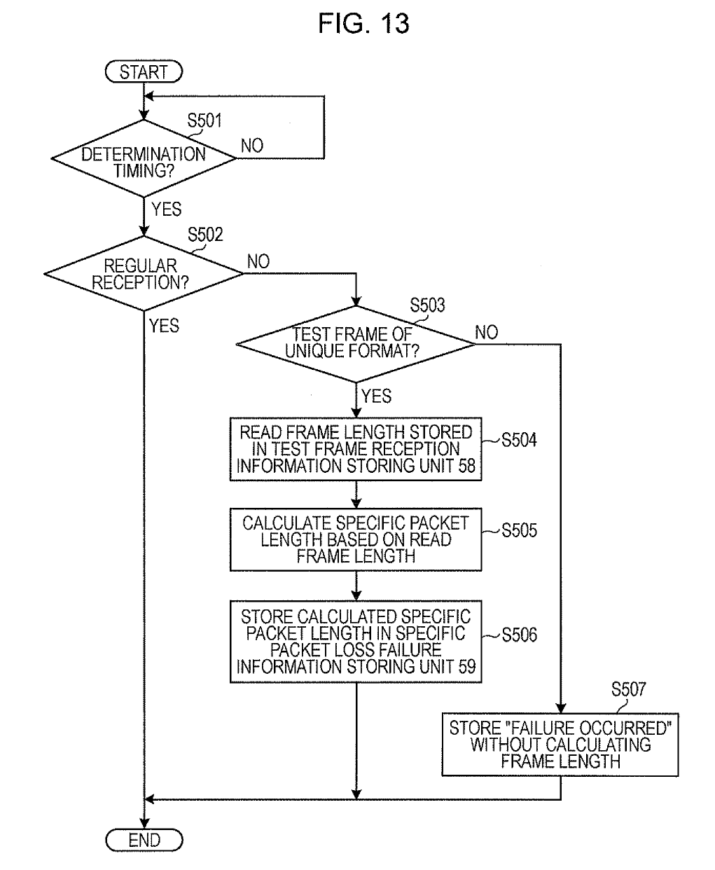

Hereinafter, a specific packet loss failure determining process using unique test frames and normal test frames according to the second embodiment is described with reference to FIG. 13, FIG. 13 is a flowchart illustrating a specific packet loss failure determining process using unique test frames and normal test frames according to the second embodiment.

As illustrated in FIG. 13, at determination timing (Yes in operation S501), the transmission apparatus according to the second embodiment determines whether regular reception of is performed (operation S502). If regular reception is performed (Yes in operation S502), the specific packet loss failure determining process ends.

On the other hand, if the transmission apparatus according to the second embodiment determines that regular reception is not performed (No in operation S502), the transmission apparatus determines whether the test frame is a unique test frame (operation S503). Specifically, the transmission apparatus determines whether the test frame to be received is a unique test frame or a normal test frame. If the test frame is a unique test frame (Yes in operation S503), the transmission apparatus calculates a specific packet length and stores it (operations S504 to S506), and the specific packet loss failure determining process ends. On the other hand, if the test frame is a normal test frame (No in operation S503), the transmission apparatus stores “failure occurred” in a predetermined storing unit without calculating a frame length (operation S507), and the specific packet loss failure determining process ends. In the example illustrated in FIG. 2, the “failure occurred” is stored in the specific packet loss failure information storing unit 59.

### Example of Process in Transmission Apparatus According to the Second Embodiment

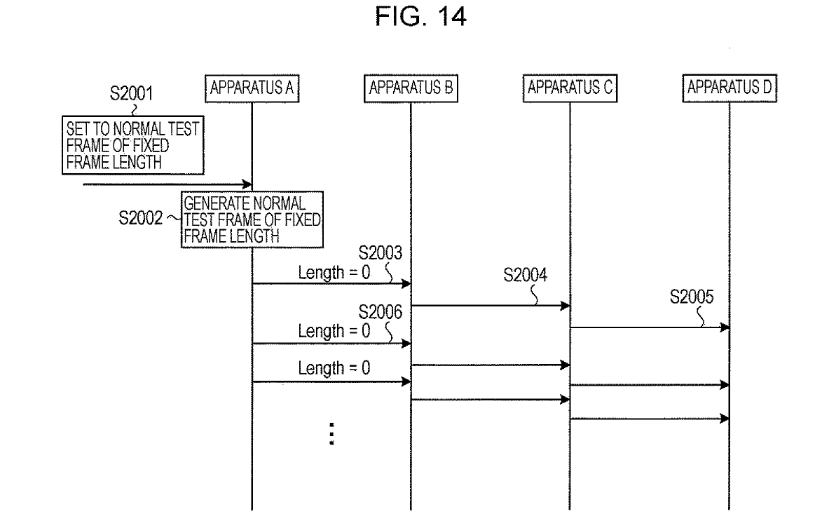

Hereinafter, an example of a process in the transmission apparatus using only normal test frames according to the second embodiment is described with reference to FIG. 14. FIG. 14 is a sequence diagram illustrating an example of a process in the transmission apparatus using only normal test frames according to the second embodiment. In the following description, apparatus A is the transmission apparatus according to this embodiment, but apparatuses B, C, and D may be or may not be the transmission apparatus according to this embodiment. As apparatuses A to D illustrated in FIG. 1, apparatus A connects to apparatus B, apparatus B connects to apparatus C, apparatus C connects to apparatus D, and occurrence of a network failure between apparatus A and apparatus D is detected by using normal test frames.

As illustrated in FIG. 14, when a normal test frame of a fixed frame length is set (operation S2001), that is, when a frame length is set to “Length=0”, apparatus A generates a normal test frame of the fixed frame length (operation S2002) and transmits the test frame to apparatus B (operation S2003). Then, the normal test frame is transmitted from apparatus B to apparatus C, and then from apparatus C to apparatus D (operations S2004 to S2005).

Then, apparatus A transmits normal test frames of the fixed frame length at regular intervals without changing the frame length at every transmission (operation S2006).

### Advantages of the Second Embodiment

As described above, according to the second embodiment, the transmission apparatus determines whether the capacity in the reserved area is changed after receiving a test frame from another transmission apparatus. If the capacity in the reserved area is changed, the transmission apparatus determines that the test frame is a unique test frame of a changeable frame length and determines whether the test frame was received at the regular interval. If unchanged capacity in the reserved area is observed, the transmission apparatus determines that the test frame is a normal test frame of a fixed frame length and determines whether the test frames was received at the regular interval. Accordingly, a normal continuity check can be easily distinguished from a continuity check according to this embodiment, and thus both types of continuity check can be easily used together.

### Third Embodiment

The transmission apparatus according to the first and second embodiments has been described above. Other than the above-described embodiments, various different embodiments can be applied. Hereinafter, another embodiment is described about a transmission apparatus according to a third embodiment.

(1) Statistical Information

In the above-described embodiments, every time a specific packet length is calculated, the specific packet length is simply stored. However, the present invention is not limited to this, but the specific packet length can be stored as statistical information.

Specifically, after a frame length of a test frame is calculated, the transmission apparatus according to the third embodiment stores the number of times when the test frame was not received and the calculated frame length as statistical information indicating a network failure. For example, if it is determined that a test frame was not received and if a specific packet length is calculated, the specific packet length is stored as statistical information. The statistical information is classified by specific packet length, estimated source, and estimated reception time.

As described above, the transmission apparatus according to the third embodiment stores the number of times when the test frame was not received and a calculated frame length of a test frame as statistical information indicating a network failure. Accordingly, a status of occurrence of a network failure can be easily recognized and a network status of the entire system can be rapidly recognized.

(2) Determining Method

In the above-described embodiments, when it is determined whether test frames of changed frame lengths are received from another transmission apparatus at regular intervals, it is determined whether the test frames are received at predetermined reception timings. However, the present invention is not limited to this, but it may be determined whether the test frames are received at predetermined capacity intervals after receiving the test frames.

For example, referring to the example illustrated in FIG. 3, “maximum of changeable frame length: 2000”, “minimum of changeable frame length: 0”, and “capacity interval: 1” are set in the transmission apparatus according to the third embodiment. Thus, if the lengths of the received test frames are “1447”, “11448”, “1449”, and “1550”, it is determined that test frames are regularly received. On the other hand, if the lengths of the received test frames are “1449”, “1550”, “1”, and “2”, it is determined that test frames are not regularly received.

(3) System

Among the processes described in the embodiments, all or part of processes that are manually performed can be automatically performed in a known method (e.g., the transmission apparatus to transmit test frames automatically sets a maximum frame length from a maximum (e.g., MTU) of corresponding frame lengths). Also, the procedure of processes, the procedure of control, specific names, and information including various data and parameters (e.g., FIGS. 2 to 14) described above in the specification and the drawings can be arbitrarily modified if not otherwise specified.

The respective elements of the devices illustrated in the drawings are functional and conceptual, and are not necessarily be configured physically as illustrated in the drawings. That is, a specific form of distribution or integration of the respective devices is not limited to that illustrated in the drawings, and all or part of the devices can be functionally or physically distributed or integrated in an arbitrary unit in accordance with various loads or a usage state (e.g., in the example illustrated in FIG. 2, the frame length changing unit 45 and the test frame transmission policy storing unit 47 can be integrated and the test frame transmission process control unit 42 can be separated from the transmitting unit 40). Furthermore, in each processing function performed in each device, all or an arbitrary part thereof can be realized by a CPU and a program analyzed and executed by the CPU, or can be realized as hardware by a wired logic.

(4) Programs of Transmission Apparatus

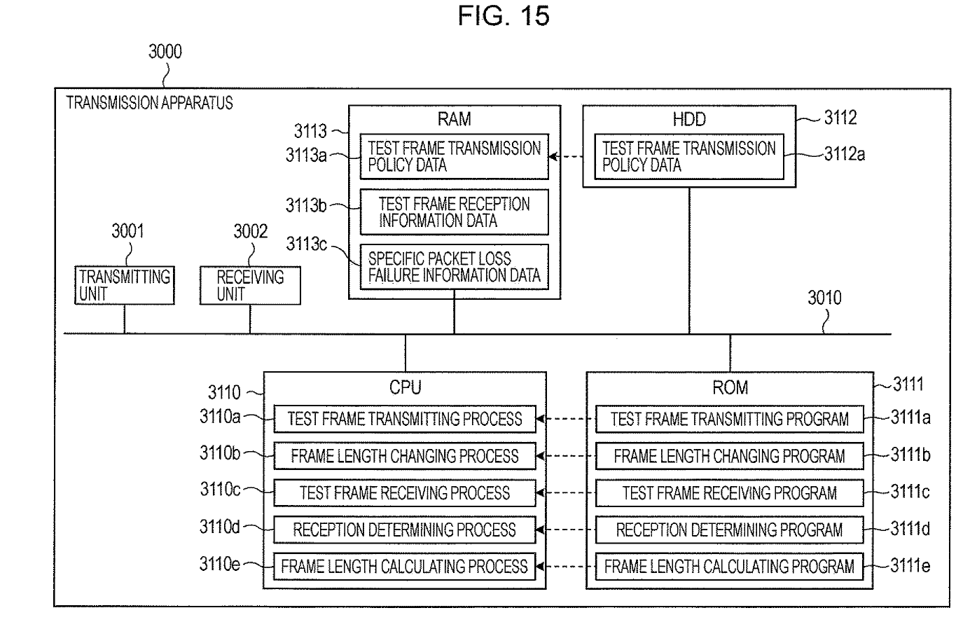

In the first embodiment, various processes are realized by hardware logic. However, the present invention is not limited to this, but the various processes can be realized by executing prepared programs in a computer. Hereinafter, an example of a computer executing a transmission apparatus control program having the same function as that of the transmission apparatus described in the first embodiment is described with reference to FIG. 15. FIG. 15 illustrates programs of the transmission apparatus according to the first embodiment.

As illustrated in FIG. 15, a transmission apparatus 3000 includes a transmitting unit 3001, a receiving unit 3002, a CPU 3110, a ROM 3111, an HDD 3112, and a RAM 3113, which are mutually connected via a bus 3010 or the like.

The ROM 3111 stores control programs having the same functions as those of the test frame transmitting unit 44, the frame length changing unit 45, the test frame receiving unit 54, the reception determining unit 55, and the frame length calculating unit 56 described in the first embodiment. That is, as illustrated in FIG. 15, the ROM 3111 stores a test frame transmitting program 3111a, a frame length changing program 3111b, a test frame receiving program 3111c, a reception determining program 3111d, and a frame length calculating program 3111e. These programs 3111a to 3111e can be appropriately integrated or separated, as the respective elements of the transmission apparatus illustrated in FIG. 2.

When the CPU 3110 reads those programs 3111a to 3111e from the ROM 3111 and executes them, the programs 3111a to 3111e function as a test frame transmitting process 3110a, a frame length changing process 3110b, a test frame receiving process 3110c, a reception determining process 3110d, and a frame length calculating process 3110e, respectively, as illustrated in FIG. 15. The processes 3110a to 3110e correspond to the test frame transmitting unit 44, the frame length changing unit 45, the test frame receiving unit 54, the reception determining unit 55, and the frame length calculating unit 56 illustrated in FIG. 2.

The CPU 3110 executes the transmission apparatus control program based on test frame transmission policy data 3113a, test frame reception information data 3113b, and specific packet loss failure information data 3113c stored in the RAM 3113.

The programs 3111a to 3111e described in this embodiment need not always be stored originally in the ROM. Those programs may be stored in a portable physical medium inserted into the transmission apparatus, such as a memory card, a flexible disk, a CD-ROM, an MO disc, a DVD, a magneto-optical disc, or an IC card, or a fixed physical medium, such as an HDD provided inside or outside the transmission apparatus. Alternatively, the programs may be stored in another computer (or server) connected to the transmission apparatus via a public line, the Internet, a LAN, or a WAN. In that case, the transmission apparatus reads the respective programs from the medium or the computer and executes the programs.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A transmission apparatus communicating test frames to test connectivity between apparatuses at regular intervals, the transmission apparatus comprising:
a frame length changing unit changing a frame length at every transmission when the test frames are transmitted to other transmission apparatus at the regular intervals;
a reception determining unit determining whether the test frames having changed frame lengths transmitted from the other transmission apparatus at the regular intervals have been received at the regular intervals; and
a frame length calculating unit calculating, if the reception determining unit determines that a test frame has not been received, the frame length of the test frame that has not been received.

2. The transmission apparatus according to claim 1, wherein the frame length changing unit changes the frame length by changing the capacity in a reserved area, which is an unused area of the test frame.

3. The transmission apparatus according to claim 2, further comprising:
a reserved area determining unit determining whether the capacity in the reserved area is changed after receiving the test frame from the other apparatus, wherein,
if the reserved area determining unit determines that the capacity in the reserved area is changed, the reception determining unit determines that the test frame is a unique test frame having a changed frame length and determines whether the test frame was received at the regular interval, and
if the reserved area determining unit determines that the capacity in the reserved area is not changed, the reception determining unit determines that the test frame is a normal test frame having a fixed frame length and determines whether the test frame was received at the regular interval.

4. The transmission apparatus according to claim 1, wherein the frame length changing unit regularly changes the frame length in the range of a preset maximum frame length and/or minimum frame length.

5. The transmission apparatus according to claim 1, further comprising:
a statistical information storing unit storing a number of times that the test frame was not received and a calculated frame length as statistical information indicating a network failure after the frame length calculating unit calculates the frame length of the test frame.

6. A test method in a system for mutually communicating, between a transmission apparatus and an other transmission apparatus, test frames to test connectivity between the transmission apparatuses, the test method comprising:
transmitting the test frames to the other transmission apparatus at regular intervals;
changing a frame length of each of the test frames at every transmission;
determining whether the test frames having changed frame lengths transmitted from the other transmission apparatus at the regular intervals have been received at the regular intervals; and
calculating a frame length of a test frame that has not been received if the test frame has not been received.

7. A recording medium containing a transmission apparatus control program allowing a computer to execute a method for mutually communicating, between a transmission apparatus and an other transmission apparatus, test frames to test connectivity between the transmission apparatuses at regular intervals, the program allowing the computer to execute:
transmitting the test frames to the other transmission apparatus at regular intervals;
changing a frame length of each of the test frames at every transmission;
determining whether the test frames having changed frame lengths transmitted from the other transmission apparatus at the regular intervals have been received at the regular intervals; and
calculating a frame length of a test frame that has not been received, if the test frame has not been received.
